(19) United States
(12) Patent Application Publication
(10) Pub. No.: US 2019/0097181 A1
(43) Pub. Date: Mar. 28, 2019

(54) ELECTRIC STORAGE DEVICE

(71) Applicant: Murata Manufacturing Co., Ltd., Nagaokakyo-shi (JP)

(72) Inventors: Masahiro Otsuka, Nagaokakyo-shi (JP); Toru Kawai, Nagaokakyo-shi (JP); Masashi Higuchi, Nagaokakyo-shi (JP); Takuya Kenko, Nagaokakyo-shi (JP)

(21) Appl. No.: 16/201,006

(22) Filed: Nov. 27, 2018

Related U.S. Application Data
(63) Continuation of application No. PCT/JP2017/005431, filed on Feb. 15, 2017.

(30) Foreign Application Priority Data
May 31, 2016 (JP) 2016-108292

(51) Int. Cl. H01M 2/02; H01G 11/78; H01G 11/26; H01G 11/52; H01M 10/04; H01M 4/02

(52) U.S. Cl. CPC H01M 2/02; H01G 11/78; H01G 11/26; H01M 2004/021; H01M 10/04; H01M 4/02; H01G 11/52

(57) ABSTRACT

An electric storage device comprises a rectangular parallelepiped case including first and second opposed main walls which are separated in a thickness direction of the case. An integrated electrode body is located in the case between the first and second main walls. The integrated electrode body includes a positive electrode, a negative electrode, and a separator disposed between the positive and the negative electrodes. The electrode body has a bending strength which is higher than bending strength of the first main wall which is physically coupled to the electrode body. An electrolyte is located in the case.

### CROSS REFERENCE TO RELATED APPLICATIONS

The present application is a continuation of PCT/JP2017/005431, filed Feb. 15, 2017, which claims priority to Japanese Patent Application No. 2016-108292, filed May 31, 2016, the entire contents of each of which are incorporated herein by reference.

### TECHNICAL FIELD

The present invention relates to an electric storage device.

### BACKGROUND ART

Conventionally, electric storage devices have been used as power sources for various kinds of electronic devices. For example, Japanese Patent Application Laid-open No. 2015-146252 (Patent Document 1) discloses an electric storage device including an electrode assembly (electrode body) housed in a case. In the electric storage device disclosed in Patent Document 1, spacers for adjusting the gap between the electrode assembly and the inner surfaces of the case are provided on opposite sides of the electrode assembly.

Recently, the thicknesses of electronic devices have been reduced, and accordingly, reduction of the thicknesses of electric storage devices has been increasingly desired. It is a main purpose of the present invention to provide a thin electric storage device.

### BRIEF DESCRIPTION OF THE INVENTION

In an aspect of the invention, an electric storage device includes a generally rectangular parallelepiped case including first and second opposed main walls which are separated in a thickness direction of the case. An integrated electrode body is located in the case between the first and second main walls. The integrated electrode body includes a positive electrode, a negative electrode, and a separator disposed between the positive and the negative electrodes. The electrode body has bending strength which is higher than bending strength of the first main wall. The first main wall is physically coupled to the electrode body. An an electrolyte located in the case.

In a preferred embodiment, the first main wall has a thickness of not more than 200 μ. In a more preferred embodiment, the first main wall of the case has a thickness of not more than 100 μ.

In one embodiment, the first main wall and the electrode body are joined together by a plurality of joining parts. Preferably the first main wall has first and second virtual diagonal lines extending between opposite corners of the first main wall and each of the joining part extends over at least one of virtual diagonal lines.

In a preferred embodiment, the case is equipotential with an electrode positioned on an outermost layer of the electrode body.

In the electric storage device according to an aspect of the present invention, the electrode body has bending strength higher which is higher than that of the first main wall and is joined with the first main wall. With this configuration, for example, when the first main wall is thin and the first main wall has low strength, deformation or the like of the first main wall is reduced by the electrode body because the first main wall is joined with the high-strength electrode body. Thus, the thickness of the first main wall can be reduced. Accordingly, the thickness of the electric storage device can be reduced.

In this case, a part having low bending strength at the first main wall 21 is joined with the electrode body having high bending strength, and thus deformation of the part is reduced by the electrode body. Accordingly, the thickness of the first main wall can be further reduced. As a result, the thickness of the electric storage device can be further reduced.

In the electric storage device according to the present invention, the joining part is preferably provided over at least one virtual diagonal line of the first main wall. In this case, the first main wall can have higher bending strength. Thus, the thickness of the first main wall can be reduced. As a result, the thickness of the electric storage device can be further reduced.

In the electric storage device according to the present invention, the case is preferably equipotential with an electrode positioned on an outermost layer of the electrode body. In this case, no short-circuit occurs even when the case and the electrode body contact with each other.

### Advantageous effect of the invention

The present invention can provide a thin electric storage device.

### BRIEF DESCRIPTION OF DRAWINGS

FIG. 1 is a schematic perspective view of an electric storage device according to a first embodiment.

FIG. 2 is a schematic plan view of the electric storage device according to the first embodiment.

FIG. 3 is a schematic cross-sectional view taken along line III-III in FIG. 1.

FIG. 4 is a schematic plan view of the electric storage device according to the first embodiment.

FIG. 5 is a schematic plan view of an electric storage device according to a second embodiment.

FIG. 6 is a schematic plan view of an electric storage device according to a third embodiment.

### DETAILED DESCRIPTION OF THE PREFERRED EMBODIMENTS

Exemplary preferred embodiments of the present invention will be described below. The following embodiments are merely exemplary and the present invention is not limited to the following embodiments.

In drawings referred to in the embodiments and the like, components having effectively identical functions will be denoted by an identical reference sign. The drawings referred to in the embodiments and the like are schematically illustrated. For example, the dimensional ratios of objects illustrated in the drawings are different from the dimensional ratio of objects in reality in some cases. For example, the dimensional ratios of objects are also different between the drawings in some cases. For example, specific dimensional ratios of objects should be determined based on the following description.

### First Embodiment

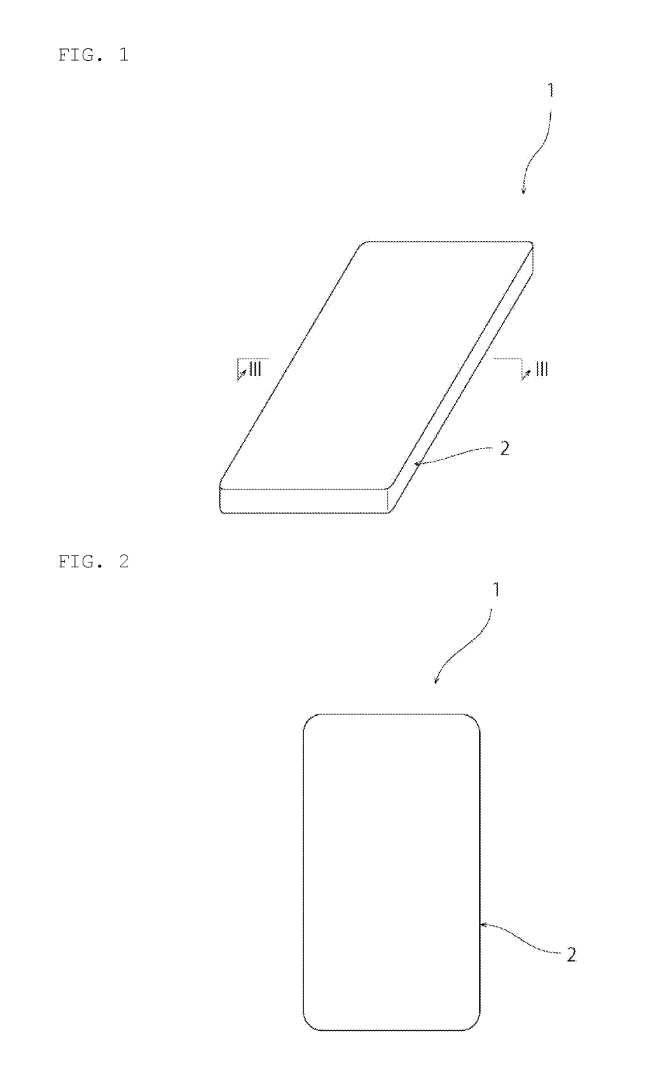

An electric storage device 1 illustrated in FIGS. 1 to 4 includes an electrolyte 4 such as electrolytic solution or gel electrolyte. Specifically, the electric storage device 1 may be, for example, a battery such as a secondary battery, or a capacitor such as an electric double-layer capacitor.

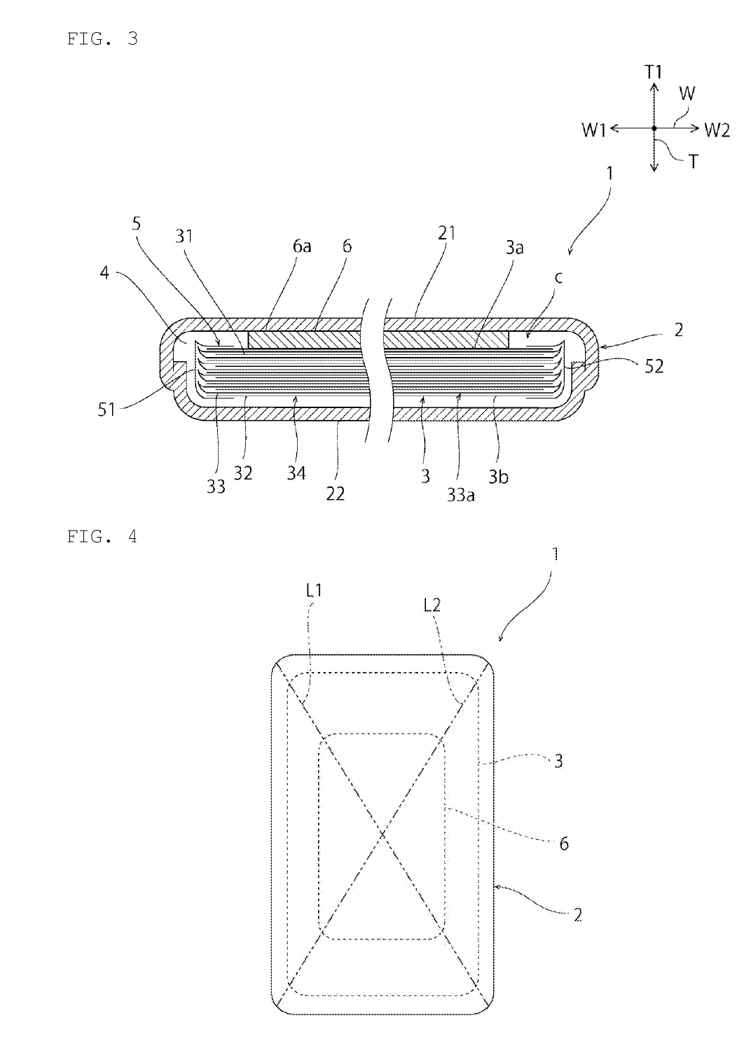

As illustrated in FIG. 3, the electric storage device 1 includes a case 2 having a substantially rectangular parallelepiped shape. More particularly, the case 2 has a rectangular shape with rounded corners in plan view (i.e., as viewed in FIG. 2). The case 2 includes opposing first and second main walls 21 and 22 which are spaced apart in a thickness direction T. The thicknesses of the first and second main walls 21 and 22 are preferably 200 μm or smaller, and 100 μm or smaller, respectively. The thicknesses of the main walls 21 and 22 can be obtained by measuring the thicknesses of the main walls 21 and 22 at their geometric centers in plan view through a digital micro meter.

The case 2 is preferably made of a material unlikely to react with the electrolyte 4 which is described in further detail below. The case 2 may be made of an insulator or a conductor such as metal. The case 2 may be made of a conductor having an inner surface coated with an insulation coating film.

Although not illustrated in FIG. 1, the case 2 may be provided with an electrode terminal or with both of a positive electrode terminal and a negative electrode terminal. Alternatively, one of the terminals may be provided and the other may be achieved by the case 2 made of a conductor.

As illustrated in FIG. 3, an electrode body 3 is disposed inside the case 2. The electrode body 3 includes a plurality of rectangular positive electrodes 31, a plurality of rectangular negative electrodes 32, and a plurality of separators 33. Each respective pair of adjacent positive and negative electrode 31 face one other with a respective separator 33 interposed there between in a thickness direction T. Each separator 33 insulates its associated pair of opposing positive and negative electrodes 31 and 32. In the preferred embodiments, adjacent separators 33 having a respective positive electrode 31 interposed there between are connected with each other at their side edges to form a bag shaped separator 33a. A respective positive electrode 31 is disposed in each bag-shaped separator 33a. While this is preferred, the invention is not so limited. Adjacent separators need not be joined into a bag shape. In addition, a single sheet which zigzags back and forth between adjacent pairs of electrodes may be provided. With this structure, a portion of the separator is located between each adjacent pair of positive and negative electrodes.

In this preferred embodiment, the electrode body 3 is a laminated electrode body obtained by laminating one or more sets of electrode pairs, each pair including a respective sheet shaped positive electrode 31, a respective sheet shaped separator 33, and a respective sheet shaped negative electrode 32. However, the present invention is not so limited. In the present invention, the electrode body is not particularly limited as long as the electrode body has a configuration that allows accumulation of electrical power. For example, the electrode body may be a wound body obtained by winding a lamination sheet in which at least one set of a positive electrode, a separator, and a negative electrode are laminated together. However, the electrode body is preferably a laminated electrode body to reduce the thickness of the electric storage device.

The configuration of each of the positive electrodes 31 may be determined as appropriate in accordance with the kind of the electric storage device 1. For example, when the electric storage device 1 is a secondary battery, the positive electrodes 31 may include a positive electrode collector, and an active material layer provided on at least one surface of the positive electrode collector. For example, when the electric storage device 1 is an electric double-layer capacitor, the positive electrodes 31 may include a positive electrode collector and a polarizable electrode layer provided on at least one surface of the positive electrode collector. Typically, the positive electrode 31 include a binding agent. Specifically, the binding agent is included in, for example, the positive-electrode active material layer or polarizable electrode layer of the positive electrodes 31.

The configuration of the negative electrodes 32 may similarly be determined as appropriate in accordance with the kind of the electric storage device 1. For example, when the electric storage device 1 is a secondary battery, the negative electrodes 32 may include a negative electrode collector and an active material layer provided on at least one surface of the negative electrode collector. For example, when the electric storage device 1 is an electric double-layer capacitor, the negative electrodes 32 may include a negative electrode collector and a polarizable electrode layer provided on at least one surface of the negative electrode collector. Typically, the negative electrodes 32 include a binding agent. Specifically, the binding agent is included in, for example, the negative-electrode active material layer or polarizable electrode layer of the negative electrodes 32.

The separators 33 may be, for example, a porous sheet including open cells through which ions in an electrolyte are movable. The separators 33 may be made of, for example, polypropylene, polyethylene, polyimide, cellulose, aramid, polyvinylidene fluoride, or Teflon (registered trademark). The separators 33 may have a surface covered by a ceramic court layer or a bonding layer. The surface of the separators 33 may have a bonding property. The separators 33 may be a single-layer film made of one kind of material, or may be a composite film or multi-layered film made of one or two or more kinds of material.

In the electric storage device 1, a plurality of sets of the positive electrode 31, the separator 33, and the negative electrode 32 are laminated in the stated order. This laminated body 34 of the positive electrodes 31, the separators 33, and the negative electrodes 32 is integrated. Specifically, the electrode body 3 further includes a tape 5. The laminated body 34 is integrated by the tape 5, thereby forming the integrated electrode body 3. The base material of the tape 5 may be, for example, polypropylene, polyethylene terephthalate, or polyimide. When the tape 5 is an adhesive tape, an adhesive agent may be made of acrylic, silicone, rubber-base material, or the like having electrolytic solution resistance. However, in the present invention, the method of integrating the positive electrodes, the separators, and the negative electrodes is not particularly limited. For example, each positive electrode may be bonded with the corresponding separator, and the separator may be bonded with the corresponding negative electrode, thereby integrating the electrode body 3.

In the present embodiment, the tape 5 includes first and second tapes 51 and 52. The first tape 51 is provided on a W1 side (the left side as viewed in FIG. 3) of the laminated body 34 and extends from a portion of the second main surface 3b, upwardly across the W1 side of the laminated body 34 onto the first main surface 3a. As a result, the first tape 51 bends an end part of the separators 33 on the W1 side upwardly toward a T1 side in the thickness direction T and fixes the end parts in this bent state.

The second tape 52 is provided on a W2 side (the right side a viewed in FIG. 3) of the laminated body 34 and extends from a portion of the second main surface 3b, upwardly across the W2 side of the laminated body 34 onto the first main surface 3a. As a result, the second tape 52 bends an end part of the separators 33 on the W2 side upwardly toward a T1 side in the thickness direction T and fixes the end parts in this bent state.

The integrated electrode body 3 preferably has bending strength (modulus of rupture) which higher than the bending strength of the first main wall 21 of the case 2. Specifically, the bending strength of the electrode body 3 is preferably more than two times larger than the bending strength of the first main wall 21 of the case 2, more preferably more than three times larger than the bending strength of the first main wall 21 of the case 2.

In the electric storage device 1, the case 2 is preferably equipotential with an electrode positioned on the outermost layer of the electrode body 3. Accordingly, no short-circuit occurs even when the case 2 contacts with the electrode positioned on the outermost layer of the electrode body 3.

The electrolyte 4 fills the case 2 and impregnates the electrode body 3.

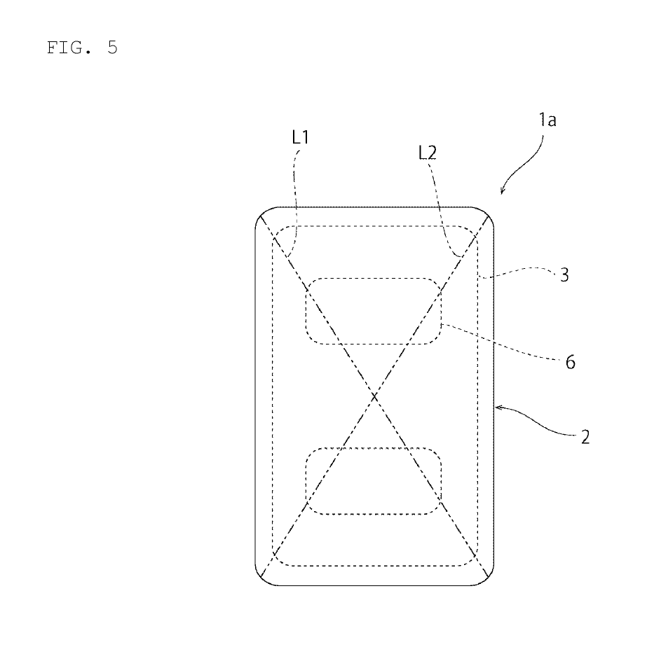

In the electric storage device 1, the main surface of the electrode body 3 and the inner surface of the case 2 are joined together by a joining part 6. Specifically, in the present embodiment, the electrode body 3 is bonded to the first main wall 21 by a bonding layer 6a. More specifically, as illustrated in FIG. 4, the bonding layer 6a (joining part 6) is provided over virtual diagonal lines Ll and L2 of the first main wall 21.

The main surface 3b of the electrode body 3 may be joined with the second main wall 22, or the main surface 3a may be joined with the first main wall 21 and the main surface 3b may be joined with the second main wall 22.

In the present invention, the electrode body and the case need not be joined together by bonding through the bonding layer. In the present invention, for example, the electrode body and the case may be directly joined together.

The bonding layer 6a is not particularly limited, but is preferably unlikely to react with the electrolyte 4. Specifically, the bonding layer 6a is preferably made of resin or a resin composition containing resin. More specifically, the bonding layer 6a is preferably made of at least one material selected from the group consisting of acrylic resin such as polyacrylonitrile (PAN) or polyacrylic acid (PAA), synthetic rubber such as styrene butadiene rubber (SBR), isoprene rubber, or ethylene propylene rubber (EPDM), natural rubber, cellulose, carboxymethyl cellulose (CMC), polyvinyl chloride (PVC), synthetic rubber such as styrene butadiene rubber (SBR), isoprene rubber, or ethylene propylene rubber (EPDM), natural rubber, polyimide (PI), polyamide (PA), polyethylene (PE), polypropylene (PP), polyethylene terephthalate (PET), polyether nitrile (PEN), polyvinylidene fluoride (PVDF), polytetrafluoroethylene (PTFE), hexafluoropropylene, fluorine resin such as perfluoroalkyl vinyl ether (PFA) or polyvinyl fluoride (PVF), fluorine rubber, silicone resin, and epoxy resin, or a resin composition containing the selected material (for example, mixture consisting of two or more kinds thereof or copolymer).

The resin included in the bonding layer 6a is preferably the same type of resin as the resin used in the binding agent included in each positive electrode 31 or negative electrode 32. In addition, the resin included in the bonding layer 6a is preferably the same type of resin as the resin used as the binding agent included in the electrode (positive electrode 31 or negative electrode 32) bonded by the bonding layer 6a. In the present embodiment, an electrode of the electrode body 3 positioned on a side (the T1 side) closest to the inner surface of the case 2 is the negative electrode 32, and the negative electrode 32 is bonded through the bonding layer 6a. For this reason, the binding agent used in the negative electrode 32 and the bonding layer 6a preferably both contain SBR. The bonding layer may contain a viscous agent including, for example, carboxymethyl cellulose (CMC) for adjusting the viscosity of slurry at formation of the bonding layer.

In an electrode such as the positive electrode 31 or the negative electrode 32, the active material layer may be provided on one or both surfaces of the collector. The negative-electrode active material layer is preferably provided on only one surface of the negative electrode collector to reduce the thickness of the electric storage device 1.

As described above, in the electric storage device 1, the first main wall 21 is joined with the electrode body 3 having bending strength higher than the bending strength of the first main wall 21. With this configuration, a part having low bending strength at the first main wall 21 is supported by the electrode body 3 having high bending strength, and thus the first main wall 21 is unlikely to deform. Thus, the thickness of the first main wall 21 can be reduced. For example, the first main wall 21 may have a thickness of 200 μm or smaller, preferably 100 μm or smaller. Accordingly, the thickness of the electric storage device 1 can be reduced.

For the same reason, the second main wall 22 is preferably joined with the electrode body 3 having high bending strength. With this configuration, the thickness of the second main wall 22 can be reduced. For example, the thickness of the second main wall 22 may be 200 μm or smaller, preferably 100 μm or smaller. Accordingly, the thickness of the electric storage device 1 can be further reduced.

The joining part 6 is preferably provided over the virtual diagonal line L1 of the first main wall 21. The first main wall 21 has low bending strength at a part on the virtual diagonal line. Thus, when the joining part 6 is provided over the virtual diagonal line L1 having low strength, the first main wall 21 can have higher strength. Thus, the thickness of the first main wall 21 can be reduced. As a result, the thickness of the electric storage device can be further reduced.

To increase the bending strength of the first main wall 21, the joining part 6 is preferably provided over the virtual diagonal lines L2 and L1. In this case, the first main wall 21 can have an even higher bending strength. As a result, the thickness of the electric storage device can be further reduced.

For the same reason, when the second main wall 22 is joined with the electrode body 3, a joining part between the second main wall 22 and the electrode body 3 is preferably provided over one, and preferably two, virtual diagonal lines of the second main wall 22.

Other exemplary preferable embodiments of the present invention will be described below. In the following description, a component having a function effectively identical to that in the above-described first embodiment will be denoted by an identical reference sign, and description thereof will be omitted.

### Second and Third Embodiments

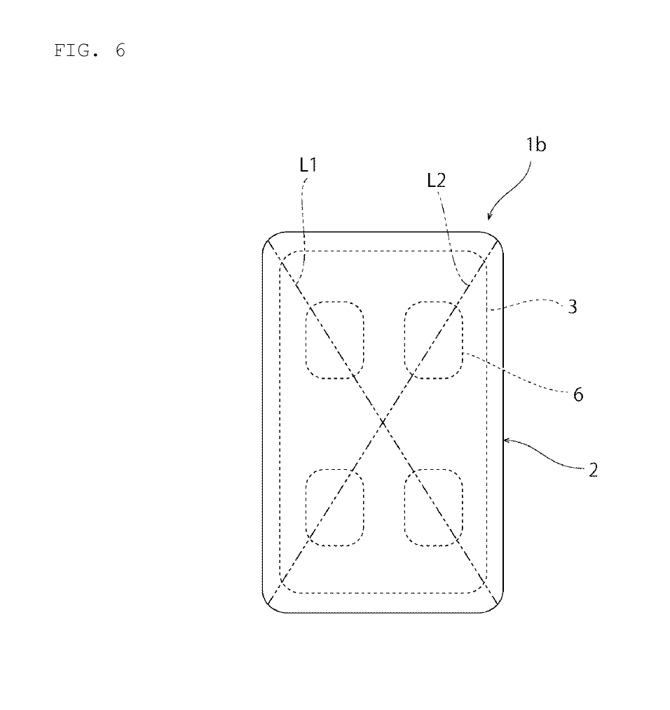

FIG. 5 is a schematic plan view of an electric storage device 1a according to a second embodiment. FIG. 6 is a schematic plan view of an electric storage device 1b according to a third embodiment.

The first embodiment describes the example in which the first main wall 21 and a main surface of the electrode body 3 are joined together by a single joining part 6.

However, the present invention is not limited to this configuration. As illustrated in FIGS. 5 and 6, the first main wall 21 and the main surface of the electrode body 3 may be joined together using a plurality of joining parts 6. When the first main wall 21 and the main surface of the electrode body 3 are joined together using a plurality of joining parts 6, a flow path of the electrolytic solution is formed between the adjacent joining parts 6. This facilitates flow of the electrolytic solution. Accordingly, the electric storage device can have an improved charging and discharging property.

### DESCRIPTION OF REFERENCE SYMBOLS

1, 1a, 1b: Electric storage device

2: Case

3: Electrode body

3a: First main surface

3b: Second main surface

4: Electrolyte

5: Tape

6: Joining part

6a: Bonding layer

21: First main wall

22: Second main wall

31: Positive electrode

32: Negative electrode

33: Separator

33a: Bag-shaped separator

34: Laminated body

51: First tape

52: Second tape

L1, L2: Virtual diagonal line

1. An electric storage device comprising:
a generally rectangular parallelepiped case including first and second opposed main walls which are separated in a thickness direction of the case;
an integrated electrode body located in the case between the first and second main walls, the integrated electrode body including a positive electrode, a negative electrode, and a separator disposed between the positive and the negative electrodes, the electrode body having bending strength which is higher than bending strength of the first main wall, the first main wall being physically coupled to the electrode body; and
an electrolyte located in the case.

2. The electric storage device according to claim 1, wherein the first main wall has a thickness of not more than 200 μ.

3. The electric storage device according to claim 2, wherein the first main wall of the case has a thickness of not more than 100 μ.

4. The electric storage device according to claim 1, wherein the first main wall of the case has a thickness of 100 μ.

5. The electric storage device according to claim 1, wherein the first main wall and the electrode body are joined together by a plurality of joining parts.

6. The electric storage device according to claim 5, wherein the first main wall has first and second virtual diagonal lines extending between opposite corners of the first main wall and each joining part extends over at least one of virtual diagonal lines.

7. The electric storage device according to claim 6, wherein each of the joining parts extends over both of the first and second imaginary diagonal lines.

8. The electric storage device according to claim 1, wherein the first main wall has first and second virtual diagonal lines extending between opposite corners of the first main wall and the joining part extends over at least one of virtual diagonal lines.

9. The electric storage device according to claim 8, wherein each of the joining part extends over both of the first and second imaginary diagonal lines.

10. The electric storage device according to claim 1, wherein the case is equipotential with an electrode positioned on an outermost layer of the electrode body.
